(19) United States
(12) Patent Application Publication
(10) Pub. No.: US 2003/0009697 A1
(43) Pub. Date: Jan. 9, 2003

(54) Server system and security system

(76) Inventors: Masakazu Uehata, Chiba-shi (JP); Satoshi Kawatani, Chiba-shi (JP); Naoto Takano, Chiba-shi (JP)

Correspondence Address: ADAMS & WILKS, 31st Floor, 50 Broadway, New York, NY, 10004, US

(21) Appl. No.: 10/076,742

(22) Filed: Feb. 14, 2002

(30) Foreign Application Priority Data
Feb. 23, 2001 (JP) 2001-048262

(51) Int. Cl. G06F 12/14; G06F 15/173

(52) U.S. Cl. 713/201; 709/223

(57) ABSTRACT

Disclosed are a server system and a security system equipped with a function for preventing illegitimate alteration of data, which are simple and inexpensive, and are capable of operating safely on a 24-hour basis. In a server system equipped with a hard disk drive, which stores at least an operating system, an application software and a content data, and receives connections from a plurality of clients through a network, the hard disk drive is provided with a mode changing switch capable of physically switching the mode of the hard disk drive between a normal mode in which writing to the hard disk drive can be performed and a read-only mode in which writing cannot be performed, whereby the hard disk drive can be operated in the read-only mode.

### BACKGROUND OF THE INVENTION

1. Field of the Invention

The present invention relates to a server system and a security system having a function for preventing illegitimate alteration of data, which are simple and inexpensive, and are capable of operating safely on a 24-hour basis.

2. Description of the Related Art

Due to an appearance of communications services for connecting to the Internet via ISDN, ASDL or CATV at high speed and at a flat rate, content servers for such content as individual and corporate web pages are being operated in great numbers.

When such a content server is to be operated, it is necessary to monitor the system operation and to take security measures, and costs relating to the security measures become greater than hardware costs. Therefore, when the server is to be operated on an individual basis, or is otherwise to be operated at a low cost, advanced security measures can not be employed. Thus, the server is always exposed to threats, such as hacker attacks intended to illegitimately alter data or use the server as a stepping stone, or virus contamination.

As described above, communications environment in which continual connection (to the Internet) is possible on an individual basis, is now being established. The current situation being as such, there is a desire for a server system, which is simple and inexpensive and can be operated in a reliable manner.

### SUMMARY OF THE INVENTION

In light of such circumstances, the present invention has been made, and has an object thereof to provide a server system and a security system, which have a function for preventing illegitimate alteration of data, are simple and inexpensive, and are capable of operating safely on a 24-hour basis.

According to a first aspect of the present invention, there is provided a server system equipped with a hard disk drive which stores at least an operating system, an application software and a content data, and receives connections from a plurality of clients through a network, characterized in that the hard disk drive is provided with a mode changing switch capable of physically switching the mode of the hard disk drive between a normal mode in which writing to the hard disk drive can be performed and a read-only mode in which writing cannot be performed, whereby the hard disk drive can be operated in the read-only mode.

According to a second aspect of the present invention, in the first aspect of the invention, a server system is characterized by further comprising a sub hard disk drive composed of a writable hard disk drive, which is driven separately and in association with the hard disk, to which a log file and a swap file can be written at any time.

According to a third aspect of the present invention, in the first aspect of the invention, a server system is characterized in that the operating system is Linux.

According to a fourth aspect of the present invention, in the first aspect of the invention, a server system is characterized in that: which further comprises a security system, which is operated by a sub central processing unit different from a central processing unit which is controlled by the operating system, and switching of the mode changing switch is controlled by the security system.

According to a fifth aspect of the present invention, in the forth aspect of the invention, a server system is characterized in that: the security system can be connected through the network; and the mode changing switch can be controlled through the security system.

According to a sixth aspect of the present invention, in the forth aspect of the invention, a server system is characterized in that the security system can be connected through the network, and is provided with an access judging function for judging between an access made from an internal source without going through the Internet and an access made from an external source through the Internet.

According to a seventh aspect of the present invention, in the sixth aspect of the invention, a server system is characterized in that the access judging function changes the mode changing switch to the normal mode with respect to the access made from the internal source, and changes the mode changing switch to the read-only mode with respect to the access made from the external source.

According to an eighth aspect of the present invention, in the sixth aspect of the invention, a server system is characterized in that, when the mode changing switch is in the read-only mode, the access judging function changes the mode changing switch to the normal mode with respect to the access from the internal source.

According to a ninth aspect of the present invention, in the fourth aspect of the invention, a server system is characterized by further comprising a manual switching unit for controlling the mode changing switch of the security system.

According to a tenth aspect of the present invention, in the fourth aspect of invention, a server system is characterized in that the security system is provided with an automatic rebooting means for performing a reboot, upon detecting system down of the operating system.

According to an eleventh aspect of the present invention, in the first aspect of the invention, a server system is characterized by further comprising a manual switching unit for manually performing switching of the mode changing switch.

According to a twelfth aspect of the present invention, in the eleventh aspect of the invention, a server system is characterized in that the manual switching unit is provided with an automatic rebooting means for performing a reboot, upon detecting the system down of the operating system.

According to a thirteenth aspect of the present invention, there is provided a security system which is connected to a server system to monitor the server system, the server system including a hard disk drive storing at least an operating system, an application software, and a content data, and receiving connections from a plurality of clients through a network, and the hard disk drive including a mode changing switch, which is physically capable of switching the mode of the hard disk drive between a normal mode in which writing can be performed and a read-only mode in which writing cannot be performed, the security system being characterized by comprising a mode switching means, which is operated by a sub central processing unit different from a central processing unit which is controlled by the operating system, for controlling the switching of the mode changing switch.

According to a fourteenth aspect of the present invention, in the thirteenth aspect of the invention, a security system is characterized in that the security system can be connected through the network, and can control the mode changing switch of the server system through the network.

According to a fifteenth aspect of the present invention, in the thirteenth aspect of the invention, a security system is characterized in that the security system can be connected through the network, and is provided with an access judging function for judging between an access made from an internal source without going through the Internet and an access made from an external source through the Internet.

According to a sixteenth aspect of the present invention, in the fifteenth aspect of the invention, a security system is characterized in that the access judging function changes the mode changing switch to the normal mode with respect to the access made from the internal source, and changes the mode changing switch to the read-only mode with respect to the access from the external source.

According to a seventeenth aspect of the present invention, in the fifteenth aspect of the invention, a security system is characterized in that, when the mode changing switch is in the read-only mode, the access judging function changes the mode changing switch to the normal mode with respect to the access from the internal source.

According to an eighteenth aspect of the present invention, in the thirteenth aspect of the invention, a security system is characterized by further comprising a manual switching unit for manually performing a control of the mode changing switch.

According to a nineteenth aspect of the present invention, in the thirteenth aspect of the invention, a security system is characterized by further comprising an automatic rebooting means for performing a reboot, upon detecting system down of the operating system of the server system.

According to a twentieth aspect of the present invention, there is provided a security system which is connected to a server system to monitor the server system, the server system including a hard disk drive storing at least an operating system, an application software, and a content data, and receiving connections from a plurality of clients through a network, the security system being characterized by comprising an automatic rebooting means for performing a reboot, upon detecting system down of the operating system of the server system.

### BRIEF DESCRIPTION OF THE DRAWINGS

In the accompanying drawings:

FIG. 1 is a diagram showing an outline construction of a server system according to an embodiment of the present invention;

FIG. 2 is a diagram showing an outline construction of a hard disk drive according to the embodiment of the present invention;

FIG. 3 is a diagram showing an outline construction of a security system according to the embodiment of the present invention;

FIG. 4 is a diagram showing an example of a server system according to another embodiment of the present invention;

FIG. 5 shows a diagram of an outline construction of a security system according to another embodiment of the present invention; and

FIG. 6 shows a diagram of an example of the server system according to another embodiment of the present invention.

### DETAILED DESCRIPTION OF THE PREFERRED EMBODIMENTS

Hereinafter, description will be made of the present invention with reference to embodiments thereof.

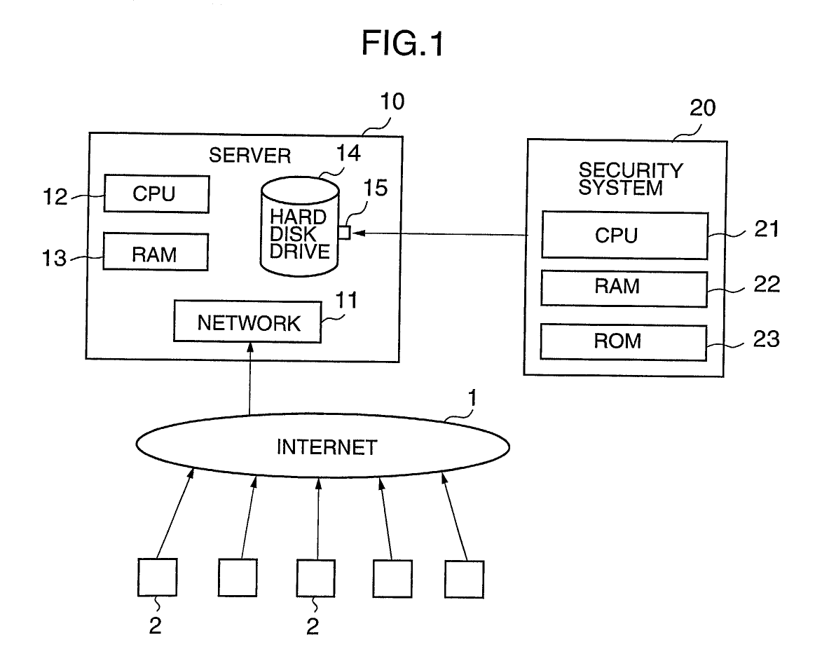

FIG. 1 shows an outline construction of a server system according to an embodiment of the present invention. As shown in FIG. 1, a connection is made via a general browser of a client 2 to a server 10 through the Internet 1. The server 10 may be, for example, a content distribution server.

Here, the server 10 has a network connections means 11 such as a router for receiving, through the Internet, a connection from the client 2 which is equipped with the browser. A CPU 12, a RAM 13, and a hard disk drive 14 are some of the main hardware of the server 10.

The hard disk drive 14 is provided with a mode changing switch 15 for physically changing a mode of the hard disk drive 14 to a normal mode in which writing can be performed and to a read-only mode in which writing cannot be performed. To the mode changing switch 15, there is connected a security system 20.

Until now, it has not been common to use the mode changing switch 15; however, here, the mode changing switch 15 is provided to a general hard disk drive which is available on the market. Therefore, the hard disk drive 14 can be realized by partially improving the general hard disk drive that is commercially available.

The security system 20 is provided with a CPU 21 which is independent from the server 10. Additionally, it is provided with a RAM 22 and a ROM 23, and can be composed of, for example, a one-chip integrated circuit.

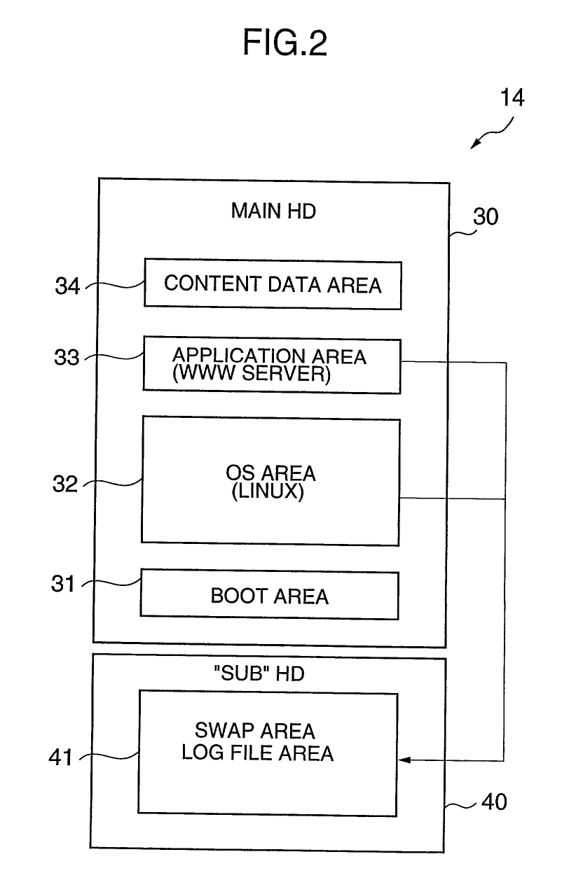

FIG. 2 shows an outline construction of the hard disk drive 14. As shown in FIG. 2, in order to operate the server system in the read-only mode, the hard disk drive 14 is provided with a sub hard disk drive 40 in addition to a main hard disk drive 30. Namely, the main hard disk drive 30 has a boot area 31 for executing booting, an OS area 32 in which an OS is installed, an applications area 33 in which there are installed various applications for operating a server system for a WWW server or other such server, and a content area 34 in which various content data is stored. The sub hard disk drive 40 is provided with a write area 41 to which an OS swap file, an application software log file and the like are written.

In addition to the main hard disk drive 30 described above, the sub hard disk drive 40 is provided to another drive so that the OS swap file, the application software log file and the like may be written to the write area 41 of the sub hard disk drive 40. As a result, the main hard disk drive 30 can be switched to the read-only mode.

Here, there are no particular restrictions on the OS, which is to be installed in the main hard disk drive 30, provided that it is capable of designating the swap area in another drive. An example of an OS that is capable of this is Linux.

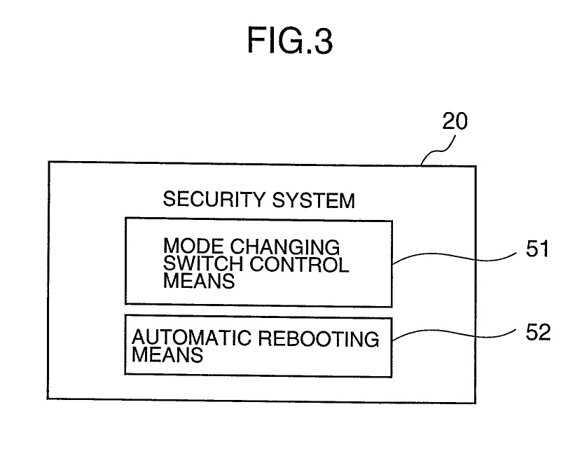

FIG. 3 shows an outline construction of the security system 20. As shown in FIG. 3, the security system 20 is provided with a mode changing switch control means 51 and automatic rebooting means 52.

The mode changing switch control means 51 is for controlling the mode changing switch 15 of the hard disk drive 14, and can change the mode to the normal mode or to the read-only mode according to an external command. Further, it is also possible to configure the control means 15 such that, after it changes the mode to the normal mode, it then automatically changes it to the read-only mode after a predetermined period of time has elapsed.

Further, the automatic rebooting means 52 monitors an activation status of the server 10, and functions to execute a system reboot in the case where the automatic rebooting means 52 detects that the system is down. In other words, in the case when the server 10 system goes down due to some cause, the automatic rebooting means 52 is configured to be able to detect this and automatically reboot the system. Note that it is also possible to configure the automatic rebooting means 52 such that it can be turned on and off from an external source. Accordingly, it is possible to maintain a state in which the system has been stopped intentionally.

In the case where the security system 30 is to be accessed from an external source, such as in the case where an access is to be made by a manager of the server 10, this is performed through the network. In this case, it is possible to make the access via the server 10 by means of a predetermined login procedure, or it is also possible to make the access directly to the security system 20 by using a dedicated independent network line.

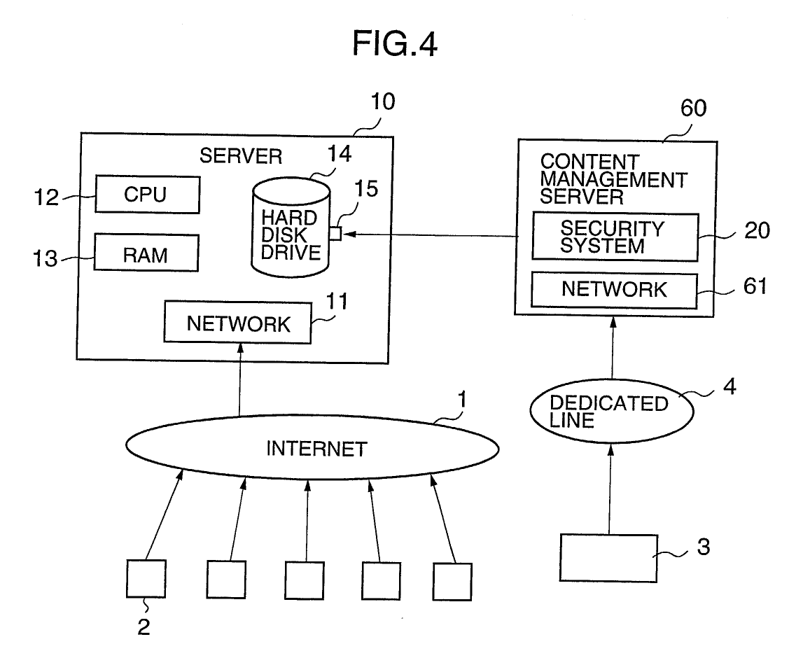

FIG. 4 shows an example of a server system in which the connection can be made to the security system 20 via the dedicated independent line. Note that the same reference numerals are assigned to those portions, which show the same operations as in FIG. 1, and redundant explanations have been thus omitted. As shown in FIG. 4, a content management server 60, which is provided with the security system 20, is connected to the server 10, and the content management server 60 has a network connection means 61. A manager 3 connects to the content management server 60 via a dedicated line 4, and changes the mode of the hard disk drive 14 to the normal mode via the security system 20. After that, the manager 3 can perform content updates and the like. Further, it is also possible to configure the automatic rebooting means 52 such that it can be turned on and off from the external source.

Further, a configuration is also possible in which the access to the security system 20 is done by means of a physical switch. That is, in the case of a home server used by a general user at home, for example, a configuration is possible in which the mode changing switch 15 of the hard disk drive 14 is manipulated through the mode changing switch control means 51 of the security system 20, by using a switch that may be manipulated from an external location. Of course, it is also possible for the mode changing switch 15 of the hard disk drive 14 to be manipulated directly from an external location.

Further, it is also possible for the security system 20 itself to have a built-in communications function for making the connection directly through the network, or for connecting indirectly through the server 10.

As described above, in the server system, the hard disk drive 14 can be operated in the read-only mode, so that it becomes possible to completely prevent illegitimate alteration of data by illegitimate access by hackers and the like. In other words, since conventional prevention against illegitimate access was performed by software, even when a highly advanced security system was built, a security hole always existed, and security management and updating was difficult. However, in the server system of the present invention, security is achieved by means of the hardware, so almost complete prevention against illegitimate alterations can be achieved.

Further, even in the case where the server 10 system goes down due to an occurrence of a system problem or the like, the automatic rebooting means 52 of the security system 20 can perform the automatic rebooting. As a result, a significant effect is produced so that it is not necessary for a person to perform the monitoring of the server 10. Therefore, the server system is also effective as a security system provided only with the automatic rebooting means 52. For example, by simply connecting the server system to a working content server, it is possible to achieve a security system 20 that can detect the system down and can automatically execute the reboot.

Note that, in the case where the hard disk drive 14 is operated in the read-only mode, illegitimate alteration is impossible, but the possibility of the system being shut down does remain. However, by providing the automatic rebooting means 52, which detects such system down and automatically executes the reboot, an effect is produced such that a more complete server system can be achieved.

As described above, according to the server system of the present invention, it is possible to achieve almost complete security at an extremely low cost. Therefore, the server system is suitable not only for the servers which are commercially operated by (service) providers and other specialists, but also for a home server used by a general user at home.

For example, in the case where the server system is used as the home server, it is desirable to configure the system such that the access to the security system 20 can be achieved by means of the physical switch provided to the external location of the server system. Also, it is desirable to configure the system such that when the direct access has been made to the server and a web page has been updated, the mode changing switch 15 is automatically changed to the read-only mode after the predetermined duration of time has elapsed. Further, when the server system is being used as the home server, the automatic reboot function is not necessarily important, but by adding this function, it becomes possible to achieve inexpensively a home server that operates on a 24-hour basis.

Further, it is also possible to provide the security system with an access judging function for automatically identifying the person making access. This is not limited to the case of the home server, but it is particularly useful when the system is used as the home server.

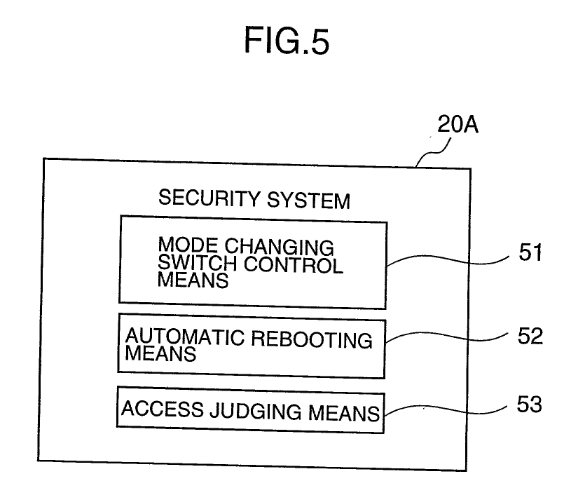

An example of such a security system is shown in FIG. 5. As shown in FIG. 5, a security system 20A is provided with the mode changing switch control means 51 and the automatic rebooting means 52, and also an access judging means 53.

Here, the access judging means 53 judges whether the access being made to the security system is a connection made from an external source through the Internet or through another network that is connected to an external source, or it is access that is being made from an internal source via a personal computer connected directly to an intranet or directly to the security system. By providing such the access judging means 53, the security system 20A can operate to change the mode changing switch to the normal mode with respect to the access being made from the internal source, and change the mode changing switch to the read-only mode with respect to the access being made from the external source. Further, when the mode changing switch 15 is in the read-only mode, the security system 20A can operate to change it to the normal mode in the case when access is made from the internal source.

Note that the access judging means 53 can easily be achieved by utilizing information from, for example, a network address translation (NAT) means that performs conversion between an external IP address and the system's own internal IP address.

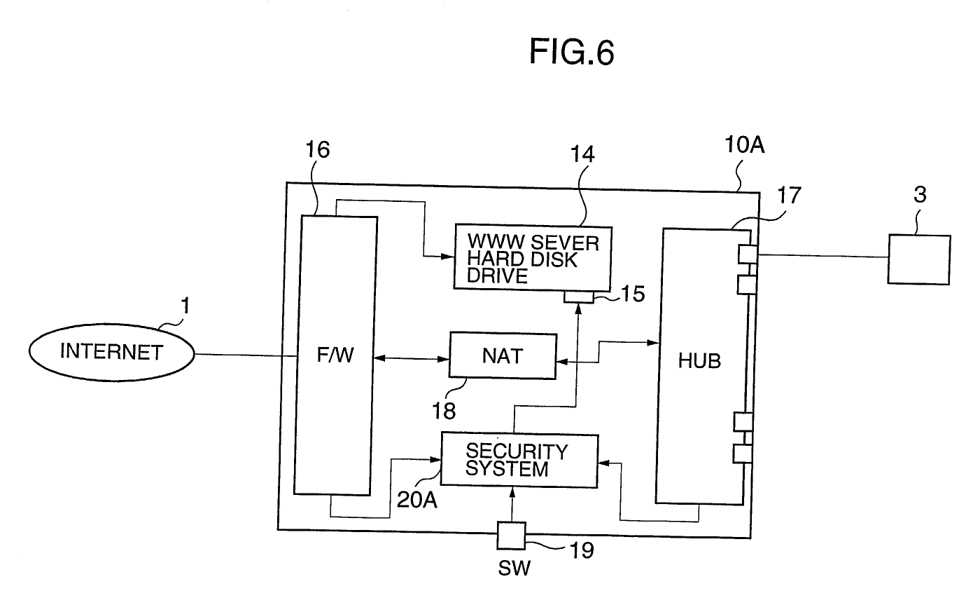

FIG. 6 shows an example of a construction of a home server equipped with the security system 20A as described above. As shown in FIG. 6, a home server 10A is provided with the hard disk drive 14 having built-in software or the like for functioning as a WWW server, and the security system 20A is connected to the mode changing switch 15 that is attached to the hard disk drive 14. Further, the home server 10A is connected to the Internet 1 via a firewall 16, and is connected through a hub 17 to the manager 3 either via an intranet or directly. Further, in the case where access is to be made from the external source into the intranet, or in the case where the access is to be made from an internal source in the intranet to the Internet, the home server 10A is equipped with an NAT means 18 for converting between the external IP address and the system's own internal IP address. Further, the security system 20A is provided with an external switch 19 for controlling the security function, namely the mode changing switch control means 51, by means of a manual operation. Note that in this home server 10A there is provided the firewall 16; however, it is not necessary that the firewall have general security functions. The firewall may simply be a network connection means for connecting to the network.

In the home server 10A as described above, operation such as the following is possible. For example, by means of the external switch 19 or automatically upon judging that the predetermined amount of time has elapsed since the manager 3 finished making access, the mode changing switch control means 51 changes the mode changing switch 15 is automatically changed by, and the hard disk drive 14 is changed to the read-only mode. When this has occurred, even if the access is made through the Internet 1, the hard disk drive 14 cannot be illegitimately altered, and thus complete security is ensured. In this state, if the manager 3 makes access, the access judging means 53 of the security system 20A judges that the access is being made from the internal source, and thus only the manager 3 can write to the hard disk drive. Further, at this time, even if the access is made through the intranet 1, for those persons who have passed through a predetermined authentication process, the mode changing switch control means 51 is controlled to allow them to write to the hard disk drive 14. Note that in such operation, the mode changing switch 15 of the hard disk drive 14 can be configured so that it always remains in the read-only mode unless the access is made by the manager 3.

Further, a configuration is also possible such that all the access from the external source and from the internal source is conducted through the security system 20A, the mode changing switch control means 51 is changed to the read-only mode when the connection comes from the external source, and it is changed to the normal mode when the connection comes from the internal source.

As explained above, according to the present invention, the server system is provided with the mode changing switch that can physically change the mode of the hard disk drive between the normal mode in which writing to the server system's hard disk drive can be performed and the read-only mode, in which the writing cannot be performed, and operations are executed in the read-only mode, whereby it is possible to provide the server system and the security system having the function of preventing illegitimate data alteration, which are simple and inexpensive, and are capable of operating safely on a 24-hour basis.

What is claimed is:

1. A server system equipped with a hard disk drive which stores at least an operating system, an application software and a content data, and receives connections from a plurality of clients through a network, wherein the hard disk drive is provided with a mode changing switch capable of physically switching the mode of the hard disk drive between a normal mode in which writing to the hard disk drive can be performed and a read-only mode in which writing cannot be performed, whereby the hard disk drive can be operated in the read-only mode.

2. A server system according to claim 1, further comprising a sub hard disk drive composed of a writable hard disk drive, which is driven separately and in association with the hard disk drive, to which a log file and a swap file can be written at any time.

3. A server system according to claim 1, wherein the operating system is Linux.

4. A server system according to claim 1, further comprising a security system, which is operated by a sub central processing unit different from a central processing unit which is controlled by the operating system, wherein switching of the mode changing switch is controlled by the security system.

5. A server system according to claim 4, wherein the security system can be connected through the network, and the mode changing switch can be controlled through the security system.

6. A server system according to claim 4, wherein the security system can be connected through the network, and is provided with an access judging function for judging between an access made from an internal source without going through the Internet and an access made from an external source through the Internet.

7. A server system according to claim 6, wherein the access judging function changes the mode changing switch to the normal mode with respect to the access made from the internal source, and changes the mode changing switch to the read-only mode with respect to the access made from the external source.

8. A server system according to claim 6, wherein, when the mode changing switch is in the read-only mode, the access judging function changes the mode changing switch to the normal mode with respect to the access from the internal source.

9. A server system according to claim 4, further comprising a manual switching unit for controlling the mode changing switch of the security system.

10. A server system according to claim 4, wherein the security system comprises an automatic rebooting means for performing a reboot, upon detecting system down of the operating system.

11. A server system according to claim 1, further comprising a manual switching unit for manually performing switching of the mode changing switch.

12. A server system according to claim 11, wherein the manual switching unit includes an automatic rebooting means for performing a reboot, upon detecting the system down of the operating system.

13. A security system, which is connected to a server system to monitor the server system,
the server system including a hard disk drive storing at least an operating system, an application software, and a content data, and receiving connections from a plurality of clients through a network, and the hard disk drive including a mode changing switch, which is physically capable of switching the mode of the hard disk drive between a normal mode in which writing can be performed and a read-only mode in which writing cannot be performed,
the security system comprising a mode switching means, which is operated by a sub central processing unit different from a central processing unit which is controlled by the operating system, for controlling the switching of the mode changing switch.

14. A security system according to claim 13, wherein the security system can be connected through the network, and can control the mode changing switch of the server system through the network.

15. A security system according to claim 13, wherein the security system can be connected through the network, and includes an access judging function for judging between an access made from an internal source without going through the Internet and an access made from an external source through the Internet.

16. A security system according to claim 15, wherein the access judging function changes the mode changing switch to the normal mode with respect to the access made from the internal source, and changes the mode changing switch to the read-only mode with respect to the access from the external source.

17. A security system according to claim 15, wherein, when the mode changing switch is in the read-only mode, the access judging function changes the mode changing switch to the normal mode with respect to the access from the internal source.

18. A security system according to claim 13, further comprising a manual switching unit for manually performing a control of the mode changing switch.

19. A security system according to claim 13, further comprising an automatic rebooting means for performing a reboot, upon detecting system down of the operating system of the server system.

20. A security system which is connected to a server system to monitor the server system,
the server system including a hard disk drive storing at least an operating system, an application software, and a content data, and receiving connections from a plurality of clients through a network,
the security system further comprising an automatic rebooting means for performing a reboot, upon detecting system down of the operating system of the server system.
